(19) United States
(12) Patent Application Publication
(10) Pub. No.: US 2008/0059409 A1
(43) Pub. Date: Mar. 6, 2008

(54) Method and Apparatus for Controlling Access to Content Streamed to Remote Devices

(75) Inventor: Marie Jose Montpetit, Jamaica Plain, MA (US)

Correspondence Address: Motorola, Inc.;Law Department, 1303 East Algonquin Road, 3rd Floor, Schaumburg, IL, 60196, US

(73) Assignee: Marie Jose Montpetit, Jamaica Plain, MA (US)

(21) Appl. No.: 11/470,490

(22) Filed: Sep. 6, 2006

(51) Int. Cl. G06F 17/30

(52) U.S. Cl. 707/2

(57) ABSTRACT

The method and apparatus allow a subscriber to limit streaming of content from subscriber premises equipment (e.g., a STB, a DVR, a PVR, etc.) or from an element in the network (e.g., a streaming server) to a mobile device such as a mobile telephone. Thus, the streaming of content can be restricted so that it is not streamed to the mobile device without some indication from the subscriber that streaming of the restricted content is authorized.

### TECHNICAL FIELD OF THE INVENTION

The invention relates to providing user control over content streamed to remote devices. More particularly, the invention relates to enabling a content subscriber to control and thereby restrict access to content streamed to a remote device, such as, for example, a wireless telephone.

### BACKGROUND OF THE INVENTION

Devices such as set-top boxes (STBs), digital video recorders (DVRs) and personal video recorders (PVRs) render content on rendering devices such as televisions and stereos. In order to provide parental control over content that is rendered, STBs, DVRs and PVRs typically are equipped to enable the subscriber to set access controls, commonly referred to as parental controls, that restrict or limit access to content. For example, a subscriber can restrict access to content by designating content that is to be restricted and by associating a personal identification number (PIN) with the content to be restricted. The restricted content can then only be accessed by entering the PIN into the STB, DVR or PVR, either directly or via a remote control device.

Recently, there has been a great deal of interest in streaming content from subscriber premises equipment such as STBs, DVRs and PVRs, for example, to remote devices such as wireless telephones. Currently, there is no way to prevent content that has been restricted by setting parental controls at the STB from being streamed from the STB to a remote device. This is because parental controls are set locally in the STB, and there is currently no provision for porting parental controls directly to a remote device. Consequently, it is possible for a user of a remote device to gain access to content that the subscriber intended to restrict them from having. This is undesirable for a variety of reasons. For example, a child using a parent's wireless telephone may be able to stream content from the STB at the home to the telephone even though the content was restricted through the setting of parental controls on the STB.

It would be advantageous to provide a way to allow a subscriber to restrict content so that it cannot be streamed from equipment located at the subscriber's premises or from a component in the network to a remote device. This would prevent users of remote devices from gaining access to content that the subscriber did not intend for them to have.

### BRIEF DESCRIPTION OF THE DRAWINGS

FIG. 1 illustrates a network diagram that demonstrates how streaming of content to a remote device may be restricted.

FIG. 2 illustrates a network diagram that demonstrates using the Session Initiation Protocol (SIP) and the Internet Multimedia Subsystem (IMS) standard.

FIG. 3 illustrates a network diagram wherein the access control algorithm is performed in the network by a network component.

FIG. 4 illustrates a flowchart for controlling streaming of content from subscriber premises equipment to a remote device.

FIG. 5 illustrates a flowchart for controlling streaming of content from a network element to a remote device.

### DETAILED DESCRIPTION OF AN EXEMPLARY EMBODIMENT

The method and apparatus allow a subscriber to limit streaming of content from subscriber premises equipment (e.g., a STB, a DVR, a PVR, etc.) or from an element in the network (e.g., a streaming server) to a mobile device such as a mobile telephone. Thus, the streaming of content can be restricted so that it is not streamed to the mobile device without some indication from the subscriber that streaming of the restricted content is authorized. The term “subscriber premises equipment”, as that term is used herein, is intended to mean any equipment located at the subscriber premises that is capable of streaming content, including, but not limited to, a STB, a DVR and a PVR. The term “mobile device”, as that term is used herein, is intended to mean any device that is capable of communicating with a wireless network, including, but not limited to, wireless or cellular telephones, personal digital assistants, personal computers (PCs), and other devices that can communicate over wireless or cellular networks.

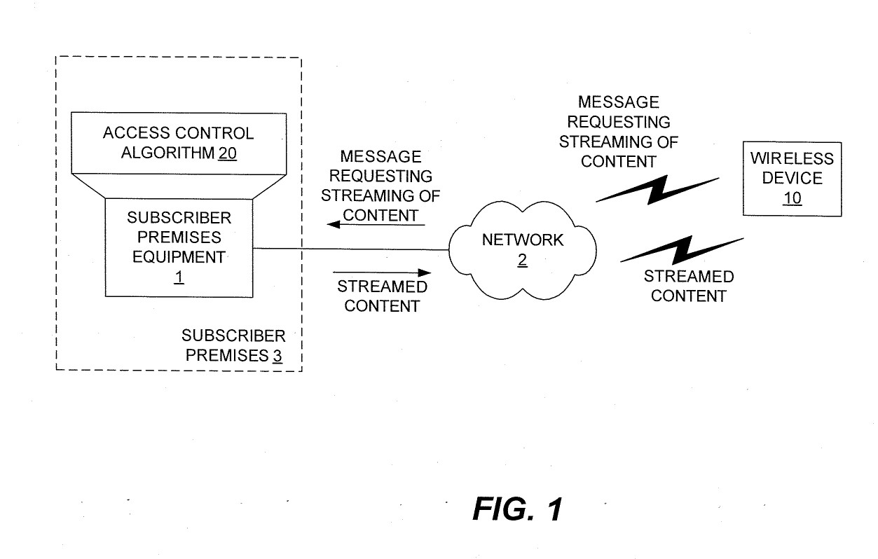

FIG. 1 illustrates a network diagram that demonstrates an example of the manner in which streaming of content to a remote device may be restricted. In this example, the content is stored on a memory device (not shown) inside of subscriber premises equipment 1, which is a STB in this example. The remote device 10 in this example is a wireless device such as, for example, a wireless telephone. When a user transmits a request to access content stored on the STB 1, the request is sent over a network 2 to the subscriber's premises 3. The STB 1 receives the request and performs an access control algorithm 20 that determines whether the requested content is restricted. If the content has not been restricted, it is streamed to the wireless device 10.

If the algorithm 20 determines that the requested content is restricted, the algorithm may cause a message to be sent to the wireless device 10 requesting that the user enter the access control identifier, which is typically the PIN. The user of the wireless device 10 may respond by sending a message to the STB 1 that includes an access control identifier. In fact, several messages may be communicated between the STB 1 and the wireless device 10 before the STB 1 receives an access control identifier. Alternatively, the access control identifier may be included in the initial request sent from the wireless device 10 to the STB 1.

The access control algorithm 20 executed by the STB 1 then determines whether the received access control identifier is the correct access control identifier. This may be accomplished in a variety of ways. For example, some STB technologies use parental control PINs to “lock” restricted channels so that they cannot be tuned to those channels. Some STB technologies encrypt content so that the content cannot be viewed without using the PIN to decrypting it. In these cases, the access control identifier received from the wireless device 10 may be used by the access control algorithm 20 to unlock the corresponding channel or decrypt the corresponding content. Alternatively, the received access control identifier may be analyzed to determine whether it matches an identifier associated with the requested content. If so, the algorithm may then cause the requested content to be streamed to the wireless device 10.

Alternatively, the wireless telephone 10 may perform the algorithm that determines whether the access control identifier entered by the user of the wireless telephone 10 corresponds to an access control identifier that has previously been associated with the requested content and stored in the wireless device 10. Yet another alternative is for this algorithm to be performed by some device (not shown) in the network 2. Those skilled in the art will understand, in view of the description provided herein, that the process of determining whether the user of the remote device will be allowed to access the requested content may be performed in a variety of different ways by a variety of different devices.

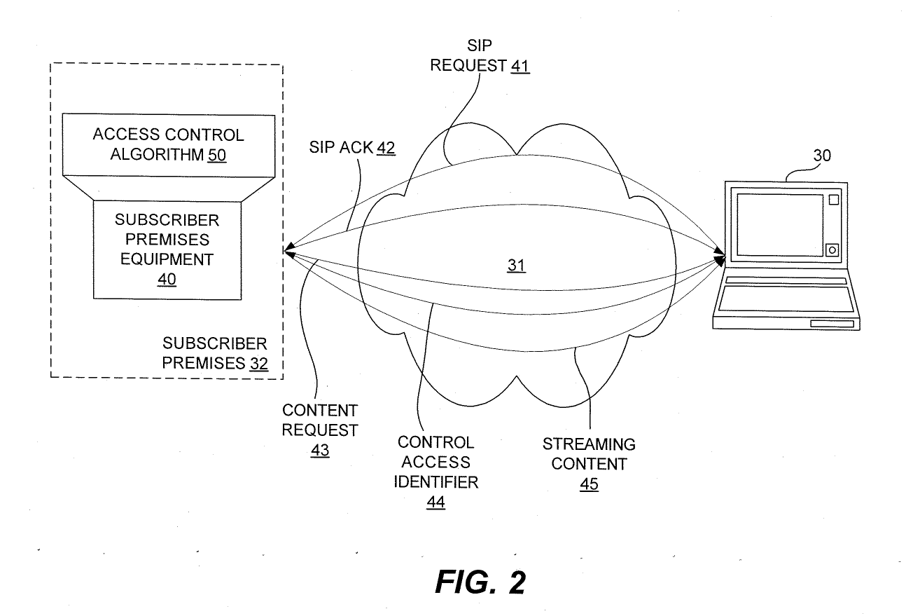

FIG. 2 illustrates a network diagram that demonstrates an example of the manner in which the tasks described above with reference to FIG. 1 may be performed using the Session Initiation Protocol (SIP) and the Internet Multimedia Subsystem (IMS) standard. SIP is an Internet Engineering Task Force (EITF) standard protocol for initiating an interactive user session that involves multimedia elements such as video, chat, voice, gaming, and virtual reality. SIP is a request-response protocol that involves requests from clients and responses from servers. IMS is a standard that governs voice and multimedia communications over packet-based Internet Protocol (IP) networks. SIP and IMS together provide a control plane that may be used by the invention to provide access control over streaming content.

As shown in FIG. 2, a SIP invite request is sent from the remote device 30 to the subscriber premises equipment 40, as indicated by arrow 41. In this example, the subscriber premises equipment 40 is a STB and the remote device 30 is a laptop computer, which are in communication with each other via a network 31. The communication link between the network 31 and the laptop computer 30 may be a wired or wireless link. The communication link between the subscriber premises 33 and the network 31 is typically a wired link that is part of the cable plant, although it may be a wireless link such as a satellite link.

In accordance with this example, the laptop computer 30 and the STB 40 are running SIP user agent (UA) software programs that enable them to communicate with each other during an SIP session. The SIP invite request includes session description protocol (SDP) information that defines the session. The STB 40 responds with an SIP acknowledgement, as indicated by arrow 42. In actuality, many exchanges will typically occur between the STB 40 and the remote device 30 when setting up the SIP session. The remote device 30 then sends a package to the STB 40 that informs the STB 40 that if the requested content has an access control identifier associated with it, to send a request to the remote device 30 for the corresponding access control identifier, as indicated by arrow 43. This may be, for example, an Extensible Markup Language (XML) form with fields to be filled in with the access control identifier. Once the fields have been filed in, the remote device 30 sends a SIP package to the remote device 30 that includes the access control identifier associated with the requested content, as indicated by arrow 44.

When the STB 40 receives the access control identifier, the algorithm 50 processes the identifier in the manner described above with reference to FIG. 1 and determines whether the identifier matches the identifier associated with the requested content. If there is a match, the content session begins and the content is streamed from the STB 40 to the remote device 30, as indicated by arrow 45. The content may be any type of content, including, but not limited to, audio, video, text and data.

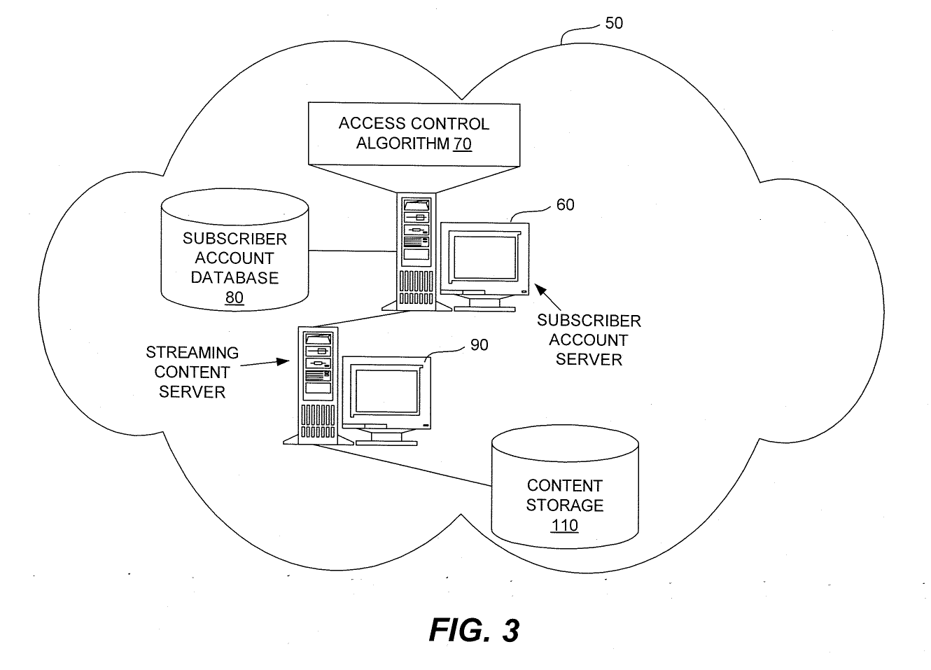

FIG. 3 illustrates a network diagram that demonstrates another exemplary embodiment. In accordance with this embodiment, the access control algorithm 70 is performed in the network 50 by a network component, which is shown to be a subscriber account server 60. The subscriber account server 60 is in communication with a subscriber account database 80, which typically contains subscriber account information, such as name, address, telephone number, programming plan, account status, remote device IDs (e.g., cell phone number), etc. In addition, in accordance with this embodiment, the database 80 also contains access control identifiers, such as parental control IDs, which are associated with particular content. The access control identifiers may be set at the subscriber premises and then uploaded to the database 80. Alternatively, they may be set in the network through interactions between the subscriber and a network element. The account server 60 is in communication with a streaming content server 90, which may be, for example, a streaming video server. The content server 90 is in communication with a content storage device 110, which holds content (e.g., video, audio, text, etc.).

When a request for a content session is sent by a remote device (not shown) to the network 50, the subscriber account server 60 executes the access control algorithm 70 described above and determines whether the requested content is restricted, and if so, whether an access control identifier has been received by from the remote device that matches the identifier associated with the content in the database 80. The server 60 typically performs several other tasks, such as determining whether the subscriber's account is current and determining whether the subscriber has a paid subscription for the requested content. If the access control identifier sent by the remote device is correct, the server 60 sends a message to the streaming content server 90 that instructs the server 90 to stream the requested content to the remote device. The server 90 then retrieves the requested content from storage device 110 and streams it to the remote device.

An alternative to the embodiment represented by the network diagram shown in FIG. 3 is to perform the algorithm 70 in some component in the network 50, but to stream the content from the STB located at the subscriber's premises rather than from the streaming server 90 located in the network 50. In this case, if the algorithm 70 determines that the access control identifier received from the remote device is correct, then the server 60 sends an instruction to the STB that instructs the STB to stream the requested content to the remote device. If the correct access control identifier is not received from the remote device, then the content is not streamed to the remote device.

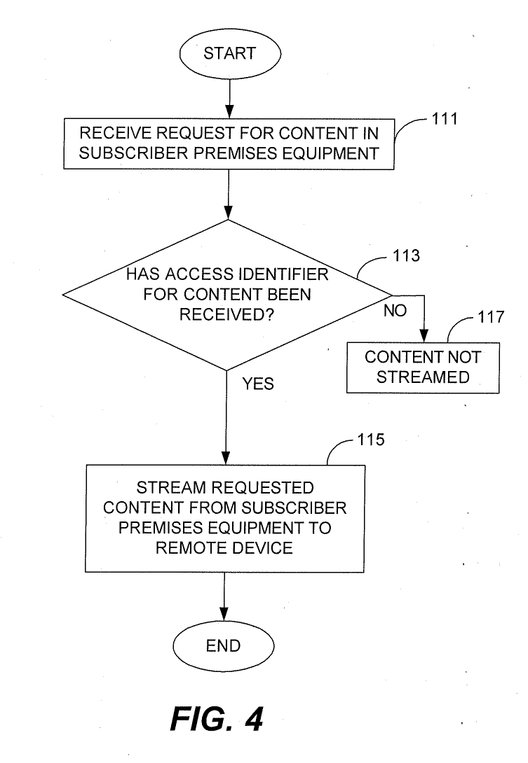

FIG. 4 illustrates a flowchart that represents the method of the invention in accordance with one exemplary embodiment. It should be noted that the method is not limited to the order of the steps shown in FIG. 4. A request for content is received at the subscriber premises equipment from a remote device, as indicated by block 111. As stated above, the subscriber premises equipment is typically a STB, but may be any device, including, for example, a DVR, a PRV, a PC, a home entertainment center, or any other device that is capable of being configured to stream content. The subscriber premises equipment then determines whether an access control identifier corresponding to the requested content has been received, as indicated by block 113. If so, the subscriber premises equipment causes the requested content to be streamed to the remote device, as indicated by block 115. Otherwise, the requested content is not streamed to the remote device, as indicated by block 117. In the latter case, a message may be sent to the remote device that indicates that the correct access control identifier has not been received by the subscriber premises equipment.

After the step represented by block 111 and before the step represented by block 113, the subscriber premises equipment may determine whether the requested content has been restricted. If so, the subscriber premises equipment may cause a message to be sent to the remote device that indicates that the requested content is restricted and prompting the user of the remote device to enter the corresponding access control identifier (not shown). If the content is not restricted, the step represented by block 113 may not be performed. Rather, the subscriber premises equipment may simply cause the requested non-restricted content to be streamed to the remote device.

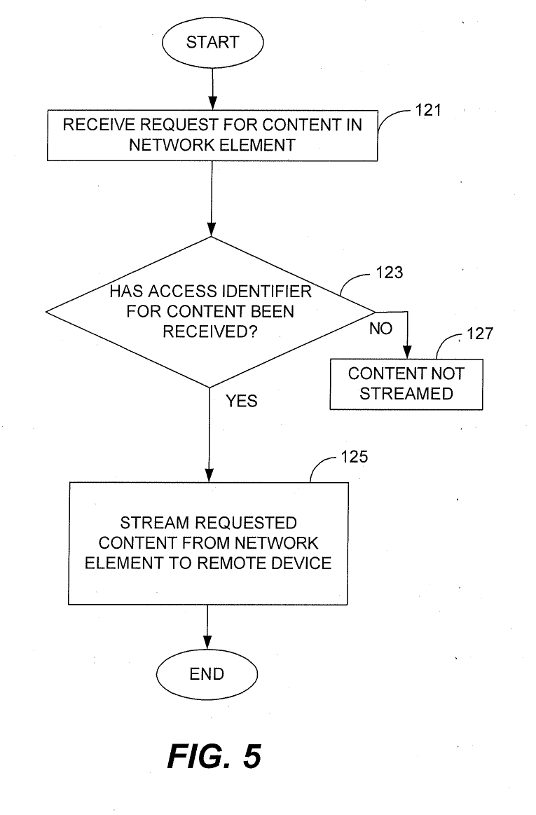

FIG. 5 illustrates a flowchart that represents the method of the invention in accordance with another exemplary embodiment. In accordance with this embodiment, the method is performed by an element within the network such as, for example, a streaming content server 60, as described above with reference to FIG. 3. A request for content is received at the network element from a remote device, as indicated by block 121. The request for content may be directed to the network element or it may be directed to some other device, such as a STB located at a subscriber premises. In the former case, the user of the remote device may be sending the request to a provider (e.g., a cable operator) that will direct the request to a particular network element. In the latter case, the user of the remote device may be sending the request to equipment located at a subscriber premises, but the request is handled by a network element that ensures that content is only streamed to the remote device when a proper access control identifier has been received from the remote device.

In all of these cases, the network element determines whether an access control identifier corresponding to the requested content has been received, as indicated by block 123. If so, the network element causes the requested content to be streamed to the remote device, as indicated by block 125. The content may be streamed from equipment located at a subscriber premises (e.g., a STB) or from a content streaming device in the network, such as the streaming content server 90 described above with reference to FIG. 3. If the network element does not determine that an access control identifier corresponding to the requested content has been received, the requested content is not streamed to the remote device, as indicated by block 127. In the latter case, a message may be sent to the remote device that indicates that the correct access control identifier has not been received by the network element.

After the step represented by block 121 and before the step represented by block 123, the network element may make a determination as to whether the requested content has been restricted. If so, the network element may cause a message to be sent to the remote device that indicates that the requested content is restricted and prompts the user of the remote device to enter the corresponding access control identifier. If the content is not restricted, the step represented by block 123 may not be performed. Rather, the network element may simply cause the requested non-restricted content to be streamed to the remote device.

The algorithms described above with reference to FIGS. 1-5 are typically performed in software being executed on one or more processors, but may be performed in hardware, software or firmware, or a combination thereof. The term “processor”, as that term is used herein, is intended to mean any computational device that can be programmed or configured to execute instructions. Thus, a processor may be hardware, software, a combination of hardware and software, firmware, or purely hardware. A processor may be, for example, a microprocessor, a microcontroller, an application specific integrated circuit (ASIC), a programmable gate array (e.g., a FPGA), a programmable logic array, a combination of discrete components, etc.

When the functions are implemented in software, the programs and associated data are typically stored in some type of computer-readable medium. Any type of computer-readable medium may be used for this purpose, such as, for example, random access memory (RAM), dynamic RAM (DRAM), flash memory, read only memory (ROM) compact disk ROM (CD-ROM), digital video disks (DVDs), magnetic disks, magnetic tapes, etc. The invention also encompasses electrical signals modulated on wired and wireless carriers (e.g., electrical conductors, wireless carrier waves, etc.) in packets and in non-packet formats.

It should be noted that the invention has been described with reference to particular exemplary embodiments and that the invention is not limited to these embodiments. As will be understood by persons skilled in the art in view of the description provided herein, modifications can be made to the embodiments described herein and all such modifications are within the scope of the invention.

What is claimed is:

1. An apparatus for controlling access by a remote device to streaming content, the apparatus comprising:
an input/output (I/O) interface configured to receive a request for content and an access control identifier from a remote device; and
a processor configured to execute an access control algorithm that determines whether the received access control identifier is a proper identifier for the requested content, wherein if the algorithm determines that the received access control identifier is a proper identifier for the requested content, the processor causes the requested content to be streamed to the remote device.

2. The apparatus of claim 1, wherein the access control identifier is a parental control access control identifier.

3. The apparatus of claim 1, wherein the apparatus is part of equipment located at a subscriber premises.

4. The apparatus of claim 3, wherein the requested content is stored on a storage medium that is part of the subscriber premises equipment.

5. The apparatus of claim 1, wherein the apparatus is part of a network element, and wherein the requested content is stored on a storage medium in the network, the storage medium being in communication with the network element.

6. The apparatus of claim 1, wherein the apparatus is part of the remote device.

7. A method for controlling access by a remote device to content, the method comprising:
receiving a request for content and an access control identifier;
determining whether the received access control identifier is proper for the content requested; and
if a determination is made that the received access control identifier is proper for the content requested, causing the requested content to be streamed to the remote device.

8. The method of claim 7, wherein the method is performed by a processor located in equipment at a subscriber's premises.

9. The method of claim 7, wherein the method is performed by a processor located in a network element.

10. The method of claim 7, wherein the method is performed by a processor located in the remote device.

11. The method of claim 7, wherein the content is stored in a content storage device located at a subscriber's premises.

12. The method of claim 7, wherein the content is stored in a content storage device located in a network.

13. A computer program for controlling access by a remote device to content, the program comprising instructions for execution by a computer and being embodied in a computer-readable medium, the program comprising:
instructions for receiving a request for content and an access control identifier;
instructions for determining whether the received access control identifier is proper for the content requested; and
instructions for causing the requested content to be streamed to the remote device if a determination is made that the received access control identifier is proper for the content requested.

14. The computer program of claim 13, wherein the program is executed by a processor located in equipment at a subscriber's premises.

15. The computer program of claim 13, wherein the program is executed by a processor located in a network element.

16. The computer program of claim 13, wherein the program is executed by a processor located in the remote device.

17. The computer program of claim 13, wherein the content is stored in a content storage device located at a subscriber's premises.

18. The computer program of claim 13, wherein the content is stored in a content storage device located in a network.
